(19) United States
(12) Patent Application Publication
(10) Pub. No.: US 2005/0057632 A1
(43) Pub. Date: Mar. 17, 2005

(54) Image recording method and image recording apparatus

(75) Inventor: Hiroshi Sunagawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/939,525

(22) Filed: Sep. 14, 2004

(30) Foreign Application Priority Data
Sep. 16, 2003 (JP) 2003-322412

(51) Int. Cl. G01D 11/00

(52) U.S. Cl. 347/100

(57) ABSTRACT

Light emitted from an illumination light source is pulse-driven in each pixel time in accordance with on-time of a spatial light modulation element array. The light emitted from the illumination light source and pulse-driven is modulated using the spatial light modulation element array in accordance with image data. And an image corresponding to the image data is recorded on a recording medium using the light modulated in accordance with the image data.

### BACKGROUND OF THE INVENTION

The present invention relates to an image recording method and an image recording apparatus with which an image corresponding to image data is recorded on a recording medium (a recording material) using exposure light modulated by a spatial light modulation element array.

For instance, as disclosed in JP 2995540 B, an apparatus is known in which light emitted from an illumination light source, such as a laser diode, is modulated by a spatial light modulation element array (hereinafter referred to as the “SLM (spatial light modulator)”), such as a linear light valve, and an image is recorded on a recording medium using the modulated exposure light.

Generally, in such an image recording apparatus, a ferroelectric liquid crystal, a grating light valve (GLV), or the like is used as the SLM. Each of them has a light modulation speed that is far faster than that of a TN (twisted nematic) liquid crystal or the like, although when it is desired to further increase the speed of CTP (computer-to-plate) where an image is directly recorded on a recording medium using digital image data created with a computer, the response speed of the SLM becomes a problem.

That is, the response speed of the SLM is not sufficiently fast with respect to the exposure time for one pixel, so that there occurs a problem in that light usage efficiency is lowered or an exposure line width and a dot ratio (image density) vary due to variations in the sensitivity level of a recording medium and the like.

This problem will be described below with reference to timing charts shown in FIGS. 4A and 4B. FIGS. 4A and 4B are each an example timing chart showing an operation of the conventional image recording apparatus. FIG. 4A shows an output waveform of the exposure light modulated by the SLM in the case where the response speed of the SLM is sufficiently fast with respect to one pixel time (exposure time for one pixel), while FIG. 4B shows an output waveform of the exposure light modulated by the SLM in the case where the response speed of the SLM is not sufficiently fast with respect to one pixel time. Here, in these drawings, a vertical axes represent light quantity of the exposure light modulated by the SLM and a horizontal axes indicate progress of time.

As shown in FIG. 4A, when the response speed of the SLM is sufficiently fast with respect to one pixel time, the output waveform of the exposure light modulated by the SLM becomes a square wave. That is, there hardly exist a rising time from a timing, at which the SLM is turned on, to a timing, at which the exposure light reaches a predetermined high light quantity, and a falling time until the light quantity returns to a predetermined low light quantity and the SLM is turned off. In this case, even if the sensitivity level of the recording medium varies, the exposure line width and the dot ratio do not vary.

As shown in FIG. 4A, when the response speed of the SLM is sufficiently fast with respect to one pixel time, during one pixel time in which the SLM is turned on, the light quantity of the exposure light modulated by the SLM becomes an almost constant high light quantity. Consequently, regardless of that the sensitivity level of the recording medium is high or low, the exposure time per pixel becomes almost the same and therefore the exposure line width and the image density also become almost the same.

In contrast to this, as shown in FIG. 4B, when the response speed of the SLM is not sufficiently fast with respect to one pixel time, the output waveform of the exposure light modulated by the SLM becomes a trapezoid wave. That is, a predetermined rising time is required until the exposure light reaches the predetermined high light quantity. In a like manner, a predetermined falling time is required until the light quantity returns to the predetermined low light quantity. In this case, when the sensitivity level of the recording medium varies, the exposure line width and the dot ratio also vary.

As shown in FIG. 4B, when the response speed of the SLM is not sufficiently fast with respect to one pixel time, variations in the light quantity of the exposure light modulated by the SLM occur during one pixel time in which the SLM is turned on. Consequently, when the sensitivity level of the recording medium is high, the exposure time per pixel becomes long, so that the exposure line width becomes thick and the image density becomes high. In contrast to this, when the sensitivity level of the recording medium is low, the exposure time per pixel becomes short, so that the exposure line width becomes thin and the image density becomes low.

In JP 2995540 B, no consideration is given to high-speed recording, so that the response speed of the SLM is not perceived as a problem as a matter of course. Although the variations in the exposure line width and the dot ratio also depend on a shape of a writing beam, the insufficient response speed of the SLM is a big factor of the variations in the exposure line width and the dot ratio, as described above. Therefore, when the exposure light is modulated using the SLM and an image recording is performed at high speed using this modulated exposure light, the variations in the exposure line width and the dot ratio due to the insufficient response speed of the SLM becomes a significant problem.

### SUMMARY OF THE INVENTION

The present invention has been made in order to solve the conventional problems described above and has an object to provide an image recording method and an image recording apparatus with which it is possible to record an image at high speed using an exposure light modulated by an SLM without causing variations in an exposure line width and a dot ratio.

In order to achieve the above-mentioned object, the present invention provides an image recording method comprising the steps of: pulse-driving light emitted from an illumination light source in each pixel time in accordance with on-time of a spatial light modulation element array; modulating the light emitted from the illumination light source and subjected to the pulse-driving using the spatial light modulation element array in accordance with image data; and recording an image corresponding to the image data on a recording medium using the light subjected to the modulating in accordance with the image data.

Preferably, a heat mode sensitive material whose low illuminance reciprocity law failure characteristic is strong is used as the recording medium.

Also, the present invention provides an image recording apparatus for recording an image corresponding to image data on a recording medium by exposing the recording medium with exposure light modulated in accordance with the image data, comprising: an exposure head for generating the exposure light; and a supporting stage for the recording medium, wherein the exposure head includes: an illumination light source; a spatial light modulation element array for modulating light emitted from the illumination light source in accordance with the image data; and an optical system lens for imaging the light modulated by the spatial light modulation element array as the exposure light on the recording medium placed on the supporting stage, wherein the light emitted from the illumination light source is pulse-driven in each pixel time in accordance with on-time of the spatial light modulation element array.

Preferably, on-time of the light emitted from the illumination light source coincides with the on-time of the spatial light modulation element array.

Preferably, a broad area array laser diode is used as the illumination light source.

Preferably, a ferroelectric liquid crystal shutter array is used as the spatial light modulation element array.

Preferably, a grating light valve is used as the spatial light modulation element array.

Preferably, a digital micromirror device is used as the spatial light modulation element array.

The present invention is adapted to: pulse-drive light emitted from an illumination light source in each pixel time in accordance with on-time of a spatial light modulation element array; modulate the light emitted from the illumination light source using the spatial light modulation element array in accordance with image data; and record an image corresponding to the image data on a recording medium using the light modulated in accordance with the image data.

With this construction, according to the present invention, even when the response speed of the spatial light modulation element array is not sufficiently fast with respect to one pixel time, it becomes possible to realize uniform high-speed image exposure and to obtain a favorable recording image with no variation in an exposure line width and a dot ratio, regardless of the sensitivity level of a recording medium.

This application claims priority on Japanese patent application No.2003-322412, the entire contents of which are hereby incorporated by reference. In addition, the entire contents of literatures cited in this specification are incorporated by reference.

### BRIEF DESCRIPTION OF THE DRAWINGS

In the accompanying drawings:

FIGS. 1A and 1B are respectively a plan view and a side view showing a construction of an image recording apparatus according to an embodiment of the present invention;

FIGS. 2A, 2B, and 2C are each an example timing chart showing an operation of the image recording apparatus shown in FIGS. 1A and 1B;

FIGS. 3A, 3B, and 3C are each another example timing chart showing the operation of the image recording apparatus shown in FIGS. 1A and 1B; and

FIGS. 4A and 4B are each an example timing chart showing an operation of a conventional image recording apparatus.

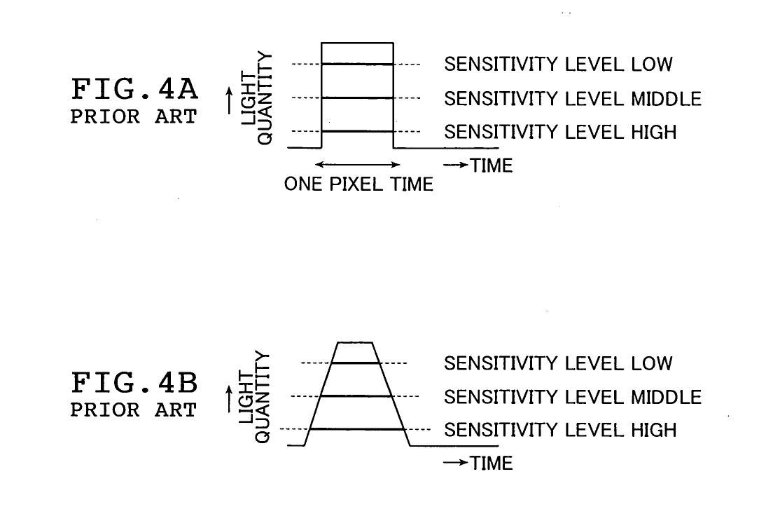

### DETAILED DESCRIPTION OF THE INVENTION

An image recording method and an image recording apparatus according to the present invention will now be described in detail based on a preferred embodiment illustrated in the accompanying drawings.

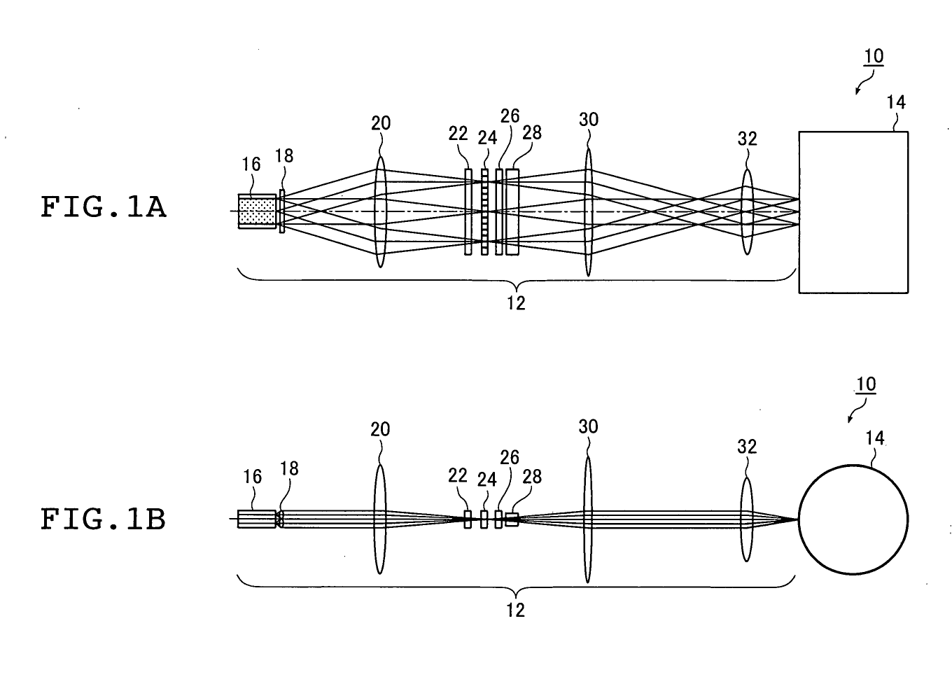

FIGS. 1A and 1B are each a conceptual construction diagram of the embodiment of the image recording apparatus according to the present invention. In more detail, FIGS. 1A and 1B are respectively a plan view and a side view of an image recording apparatus 10 according to this embodiment. In the image recording apparatus 10, light emitted from an illumination light source is modulated by a spatial light modulation element array in accordance with image data and an image corresponding to the image data is recorded on a recording medium using the modulated exposure light. The image recording apparatus 10 includes an exposure head 12 and a drum 14.

The exposure head 12 generates the exposure light modulated in accordance with the image data and includes a broad area array laser diode (hereinafter referred to as the “BALD”) 16 that is the illumination light source, a cylindrical lens 18, a collimator lens 20, a λ/2 plate 22, a ferroelectric liquid crystal shutter array 24 that is the spatial light modulation element array, a λ/2 plate 26, an analyzer 28, and two lenses 30 and 32 of a scaling and imaging optical system.

Laser light emitted from the BALD 16 is converged in a vertical direction in FIG. 1B by the cylindrical lens 18, is converted into parallel light in a vertical direction in FIG. 1A and is also converged in the vertical direction in FIG. 1B by the following collimator lens 20, and is made incident on the λ/2 plate 22.

Following this, the light polarization state of the laser light is rotated by the λ/2 plate 22 by 45° in a direction vertical to its traveling direction. Then, the laser light is modulated in accordance with image data by the following ferroelectric liquid crystal shutter array 24. When the laser light is passed through the ferroelectric liquid crystal shutter array 24, the light polarization state of the laser light is further rotated by the ferroelectric liquid crystal shutter array 24 by 90°. Next, the light polarization state of the laser light is still further rotated by the λ/2 plate 26 by 45°. After passing through the λ/2 plate 26, the laser light is made incident on the analyzer 28.

The analyzer 28 transmits only laser light, whose light polarization state has been rotated to a predetermined angle, and intercepts other laser light. The laser light having passed through the analyzer 28 is imaged at a predetermined scaling factor on a recording medium placed on the drum 14 by the two lenses 30 and 32 of the scaling and imaging optical system.

At the time of recording of an image onto the recording medium, the exposure head 12 is moved at a predetermined constant speed in an auxiliary scanning direction (axial direction of the drum 14) while emitting the exposure light modulated in accordance with the image data.

The drum 14 is a supporting stage for the recording medium. At the time of recording of an image onto the recording medium, the recording medium is placed on the outer peripheral surface of the drum 14 and the drum 14 is rotated at a predetermined constant speed in a predetermined direction (direction opposite to a main scanning direction).

In the image recording apparatus 10, by moving the exposure head 12 at the predetermined constant speed in the auxiliary scanning direction using a not-shown moving means for the exposure head 12 while rotating the drum 14 at the predetermined constant speed in the direction opposite to the main scanning direction using a not-shown rotation means for the drum 14, the recording medium placed on the outer peripheral surface of the drum 14 is two dimensionally scan-exposed by the exposure light emitted from the exposure head 12 and an image corresponding to the image data is recorded on the recording medium.

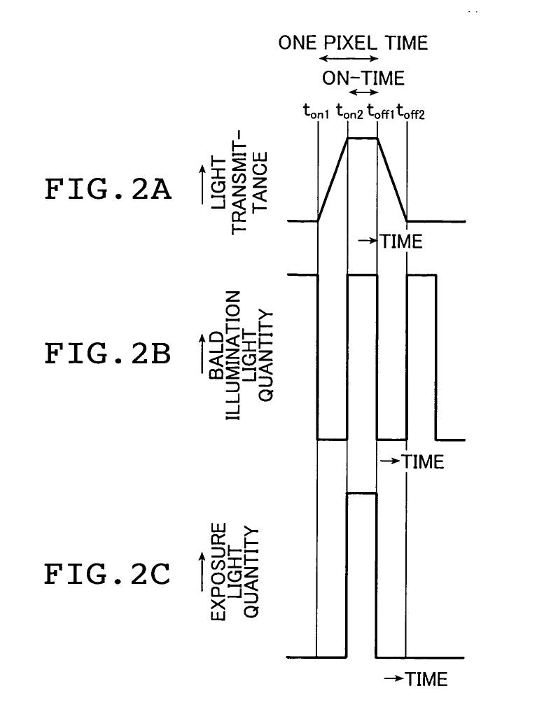

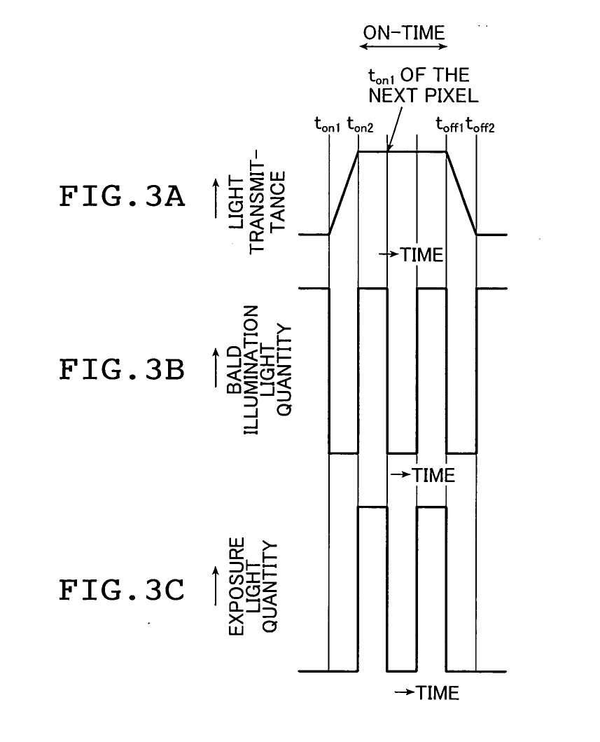

Next, an image recording method used in the image recording apparatus 10 will be described with reference to timing charts shown in FIGS. 2A, 2B, 2C, 3A, 3B, and 3C.

FIG. 2A shows a waveform expressing an operation in the case where the ferroelectric liquid crystal shutter array 24 is turned on (is set under a transmission state) only in one pixel time, while FIG. 3A shows a waveform expressing an operation in the case where the ferroelectric liquid crystal shutter array 24 is turned on in two consecutive pixel times. Also, FIGS. 2B and 3B each show an output waveform of the laser light emitted from the BALD 16. Further, FIGS. 2C and 3C each show an output waveform of the exposure light modulated by the ferroelectric liquid crystal shutter array 24.

Vertical axes in the timing charts shown in FIGS. 2A and 3A represent light transmittance of the ferroelectric liquid crystal shutter array 24. Also, vertical axes in the timing charts shown in FIGS. 2B and 3B represent output light quantity of the BALD 16. Further, vertical axes in the timing charts shown in FIGS. 2C and 3C represent exposure light quantity of the exposure light modulated by the ferroelectric liquid crystal shutter array 24. Still further, horizontal axes in the timing charts shown in FIGS. 2A, 2B, 2C, 3A, 3B, and 3C each represent passage of time.

In the timing charts shown in FIGS. 2A and 3A, the reference symbol “tₒₙ₁” indicates a timing at which a signal for increasing the transmittance (on-signal) is given to the ferroelectric liquid crystal shutter array 24, the reference symbol “tₒₙ₂” indicates a timing at which the transmittance of the ferroelectric liquid crystal shutter array 24 actually becomes sufficiently high, reference symbol “t_{off1}” indicates a timing at which a signal for decreasing the transmittance (off-signal) is given to the ferroelectric liquid crystal shutter array 24, and the reference symbol “t_{off2}” indicates a timing at which the transmittance of the ferroelectric liquid crystal shutter array 24 actually becomes sufficiently low.

In the case of the timing chart shown in FIG. 2A, for instance, one pixel time is a period of time from the timing “tₒₙ₁” to the timing “t_{off1}” and the on-time (transmission time) of the ferroelectric liquid crystal shutter array 24 is a period of time (t_{off1}-tₒₙ₂) from the timing “tₒₙ₂”, at which the operating waveform assumes to be a steady state, to the timing “t_{off1}”.

As shown in the timing charts in FIGS. 2A and 3A, the ferroelectric liquid crystal shutter array 24 requires a rising time (tₒₙ₂-tₒₙ₁) after the on-signal is given at the timing “tₒₙ₁” until the transmittance actually becomes sufficiently high at the timing “tₒₙ₂”. Also, the ferroelectric liquid crystal shutter array 24 requires a falling time (t_{off2}-t_{off1}) after the off-signal is given at the timing “t_{off1}” until the transmittance actually becomes sufficiently low at the timing “t_{off2}”.

Also, as shown in the timing charts in FIGS. 2B and 3B, the laser light emitted from the BALD 16 is pulse-driven so that its on-state (high light quantity state) and off-state (low light quantity state) are repeated by setting one pixel time as one cycle. Accordingly, the laser light emitted from the BALD 16 is set under the on-state (turn-on state) during a period of time from the timing “tₒₙ₂” to the timing “t_{off1}” within the same cycle, in each cycle, regardless of the on/off state of the ferroelectric liquid crystal shutter array 24.

Further, as shown in the timing charts in FIGS. 2B and 3B, the on-time (turn-on time) of the laser light emitted from the BALD 16 is set so as to coincide with the on-time of the ferroelectric liquid crystal shutter array 24. Note that the present invention is not limited to a case where the on-time of the laser light emitted from the BALD 16 is equal to the on-time of the ferroelectric liquid crystal shutter array 24 and there occurs no problem so long as the on-time of the laser light is shorter than the on-time of the ferroelectric liquid crystal shutter array 24.

With this construction, as shown in the timing charts in FIGS. 2C and 3C, the exposure light modulated by the ferroelectric liquid crystal shutter array 24 is set under the on-state only during a period of time in which the laser light emitted from the BALD 16 is turned on, among a period of time from the timing “tₒₙ₂” at which the ferroelectric liquid crystal shutter array 24 is turned on, and the transmittance of it actually becomes sufficiently high, to the timing “t_{off1}” at which an off-signal is given to the ferroelectric liquid crystal shutter array 24.

As described above, in the image recording apparatus 10, the BALD 16 that is the illumination light source is pulse-driven so as to coincide with the on-time of the ferroelectric liquid crystal shutter array 23. As a result, even when the response speed of the ferroelectric liquid crystal shutter array 24 is not sufficiently fast with respect to the exposure time for one pixel (one pixel time), it becomes possible to realize uniform high-speed image exposure and to obtain a favorable recording image with no variation in the exposure line width and the dot ratio, regardless of the sensitivity level of the recording medium.

It should be noted here that there occurs no problem even if the rising time (tₒₙ₂-tₒₙ₁), from a timing at which the on-signal is given to the ferroelectric liquid crystal shutter array 24, to a timing at which the transmittance actually becomes sufficiently high, differs from the falling time (t_{off2}-t_{off1}), from a timing at which the off-signal is given, to a timing at which the transmittance actually becomes sufficiently low.

In accordance with an increase in the rising time (tₒₙ₂-tₒₙ₁), the on-time (t_{off1}-tₒₙ₂) becomes short. Also, when the falling time (t_{off2}-t_{off1}) becomes long and the timing “t_{off2}” exceeds the timing “tₒₙ₂” in the next pixel, noise occurs in the output waveform of the exposure light modulated by the ferroelectric liquid crystal shutter array 24. Therefore, it is required that the timing “t_{off2}” is set at a timing preceding the timing “tₒₙ₂” in the next pixel.

Accordingly, it is required to determine the length of one pixel time, that is, frequency and duty of the laser light emitted from the BALD 16 considering the rising time (tₒₙ₂-tₒₙ₁), the falling time (t_{off2}-t_{off1}), and the on-time (t_{off1}-tₒₙ₂) of the ferroelectric liquid crystal shutter array 24. In other words, it is impossible to set the frequency and the duty of the laser light emitted from the BALD 16 so as to exceed one pixel time required to achieve a proper operation.

Also, as shown in the timing charts in FIGS. 2C and 3C, in the output waveform of the exposure light modulated by the ferroelectric liquid crystal shutter array 24, the exposure time per pixel becomes short. Therefore, it is required to set the light quantity of the laser light emitted from the BALD 16 at a light quantity at which an energy required for image exposure is given. Generally, when the reciprocity law holds, it is required to increase the light quantity of the laser light emitted from the BALD 16 according to a degree by which the exposure time is shortened.

Also, as the BALD 16 that is an illumination light source, it is preferable that a laser diode (hereinafter referred to as the “LD”) in a range of 900 nm is used considering the fact that such an LD has a high light power density as well as a long life span. As a matter of course, it is also possible to use an ordinary LD in a range of 830 nm. In this case, although almost such an LD generally has a construction of Ga (gallium)—Al (aluminum)—As (arsenic), it is preferable that an LD is used which has a construction where Al is not contained.

Also, in the image recording apparatus 10, as compared with a conventional image recording apparatus in which an illumination light source is constantly turned on and a recording medium is exposed, the exposure time for one pixel becomes short and the light quantity of exposure light per pixel time is increased accordingly. That is, in the image recording apparatus 10, short-time and high-illuminance exposure is performed. Therefore, when a thermal sensitive material, for instance, as the recording medium, in particular, a heat mode sensitive material whose low illuminance reciprocity law failure characteristic is strong like a non-processed sensitive material is exposed, there is an advantage that the energy required for the exposure becomes relatively small.

A relation of “exposure time x light quantity=exposure energy” exists, so that when the exposure time is halved, for instance, the light quantity needs to be doubled in order to obtain the same exposure energy. However, when exposure with a low light quantity is performed for a long time, a phenomenon occurs in which heat escapes and desired exposure energy cannot be obtained. In contrast to this, when exposure with a high light quantity is performed for a short time, it becomes possible to perform exposure without the escape of heat, so that exposure energy required for exposure of a recording medium becomes relatively small.

It should be noted here that the illumination light source is not limited to the BALD 16 and any other light sources are also applicable as the illumination light source. Also, the SLM is not limited to the ferroelectric liquid crystal shutter array 24, and any other transmission-type and reflection-type SLMs, such as grating light valve (GLV) and digital micromirror device (DMD), are also usable. Also, the present invention is not limited to the usage of the drum 14 and a flat plate may be used as the supporting stage for the recording medium.

Also, in the embodiment shown in FIGS. 1A and 1B, the ferroelectric liquid crystal shutter array 24 that performs line modulation is used as the spatial light modulation element array and the recording medium is two-dimensionally scan-exposed by relatively moving the exposure head 12 and the drum 14, although the present invention is not limited to this. For instance, a spatial light modulation element array that is capable of performing area modulation may be used instead. In this case, it becomes possible to perform batch area exposure where exposure light is enlarged or reduced at a predetermined scaling factor and exposure is performed without performing the scanning of a recording medium.

The above description has shown the fundamentals of the image recording method and the image recording apparatus according to the present invention.

The image recording method and the image recording apparatus according to the present invention have been described in detail above, although the present invention is not limited to the embodiment described above and it is of course possible to make various modifications and changes without departing from the gist of the present invention.

1. An image recording method comprising the steps of:
pulse-driving light emitted from an illumination light source in each pixel time in accordance with on-time of a spatial light modulation element array;
modulating the light emitted from the illumination light source and subjected to said pulse-driving using the spatial light modulation element array in accordance with image data; and
recording an image corresponding to the image data on a recording medium using the light subjected to said modulating in accordance with the image data.

2. The image recording method according to claim 1,
wherein on-time of the light emitted from the illumination light source is set to coincide with the on-time of the spatial light modulation element array.

3. The image recording method according to claim 1,
wherein a broad area array laser diode is used as the illumination light source.

4. The image recording method according to claim 1,
wherein a ferroelectric liquid crystal shutter array is used as the spatial light modulation element array.

5. The image recording method according to claim 1,
wherein a grating light valve is used as said spatial light modulation element array.

6. The image recording method according to claim 1,
wherein a digital micromirror device is used as said spatial light modulation element array.

7. The image recording method according to claim 1,
wherein a heat mode sensitive material whose low illuminance reciprocity law failure characteristic is strong is used as the recording medium.

8. An image recording apparatus for recording an image corresponding to image data on a recording medium by exposing the recording medium with exposure light modulated in accordance with the image data, comprising:
an exposure head for generating the exposure light; and
a supporting stage for the recording medium,
wherein said exposure head includes:
an illumination light source;
a spatial light modulation element array for modulating light emitted from said illumination light source in accordance with the image data; and
an optical system lens for imaging the light modulated by said spatial light modulation element array as the exposure light on the recording medium placed on said supporting stage,
wherein the light emitted from said illumination light source is pulse-driven in each pixel time in accordance with on-time of said spatial light modulation element array.

9. The image recording apparatus according to claim 8,
wherein on-time of the light emitted from said illumination light source coincides with the on-time of said spatial light modulation element array.

10. The image recording apparatus according to claim 8,
wherein a broad area array laser diode is used as said illumination light source.

11. The image recording apparatus according to claim 8,
wherein a ferroelectric liquid crystal shutter array is used as said spatial light modulation element array.

12. The image recording apparatus according to claim 8,
wherein a grating light valve is used as said spatial light modulation element array.

13. The image recording apparatus according to claim 8,
wherein a digital micromirror device is used as said spatial light modulation element array.
